(19) United States
(12) Patent Application Publication
(10) Pub. No.: US 2026/0210773 A1
(43) Pub. Date: Jul. 23, 2026

(54) Temperature Detection Circuit And Circuit Device

(71) Applicant: SEIKO EPSON CORPORATION, Tokyo (JP)

(72) Inventor: Shinichi SEKITA, Suwa (JP)

(21) Appl. No.: 19/456,508

(22) Filed: Jan. 22, 2026

(30) Foreign Application Priority Data
Jan. 23, 2025 (JP) 2025-009617

(51) Int. Cl. G01K 7/16; G01K 3/00; H02J 7/65; H02J 50/12

(52) U.S. Cl. CPC G01K 7/16; G01K 3/005; H02J 7/65; H02J 50/12

(57) ABSTRACT

A temperature detection circuit includes a bias current generation circuit that generates a bias current, a first resistance circuit through which the bias current flows, a second resistance circuit through which a second bias current flows, and a comparison circuit. The comparison circuit compares a first voltage generated by the bias current flowing through the first resistance circuit with a second voltage generated by the bias current flowing through the second resistance circuit and having a temperature characteristic different from a temperature characteristic of the first voltage, and outputs a comparison result as a temperature detection signal.

The present application is based on, and claims priority from JP Application Serial Number 2025-009617, filed January 23, 2025, the disclosure of which is hereby incorporated by reference herein in its entirety.

### BACKGROUND

### 1. Technical Field

The present disclosure relates to a temperature detection circuit, a circuit device, and the like.

### 2. Related Art

In the related art, in order to implement a thermal shutdown operation of stopping an operation of a predetermined circuit when an internal temperature reaches a predetermined temperature or higher, a temperature detection circuit that compares the predetermined temperature with the internal temperature is known. JP-A-2023-009328 discloses a technique of using a plurality of voltage generation circuits and comparing voltages output from the respective voltage generation circuits.

JP-A-2023-009328 is an example of the related art.

Since the technique disclosed in JP-A-2023-009328 has a complicated circuit configuration in which the voltage generation circuit includes an amplifier, a proposal of a temperature detection circuit that detects a desired temperature with a simpler configuration is required.

### SUMMARY

An aspect of the present disclosure relates to a temperature detection circuit including a bias current generation circuit that generates a first bias current and a second bias current, a first resistance circuit through which the first bias current flows, a second resistance circuit through which the second bias current flows, and a comparison circuit that compares a first voltage generated by the first bias current flowing through the first resistance circuit with a second voltage generated by the second bias current flowing through the second resistance circuit and having a second voltage-temperature characteristic different from a first voltage-temperature characteristic of the first voltage, and outputs a comparison result as a temperature detection signal.

Another aspect of the present disclosure relates to a circuit device including the temperature detection circuit described above, and a bandgap reference circuit, wherein the bias current generation circuit generates the first bias current and the second bias current by mirroring an internal bias current of the bandgap reference circuit.

Another aspect of the present disclosure relates to a circuit device including the temperature detection circuit described above, and a shutdown circuit that performs a shutdown operation of the circuit device when the detection signal indicating that the temperature reaches the detection target temperature is output.

### BRIEF DESCRIPTION OF THE DRAWINGS

FIG. 1 shows a configuration example of a temperature detection circuit according to an embodiment.

FIG. 2 shows a configuration example of a circuit device according to the present embodiment.

FIG. 3 shows a configuration example of a first resistance circuit.

FIG. 4 shows another configuration example of the first resistance circuit.

FIG. 5 shows another configuration example of a second resistance circuit.

FIG. 6 shows an example of a relationship between a first resistance-temperature characteristic and a second resistance-temperature characteristic.

FIG. 7 shows another example of the relationship between the first resistance-temperature characteristic and the second resistance-temperature characteristic.

FIG. 8 shows a relationship between a bandgap reference circuit and a bias current generation circuit.

FIG. 9 shows a more detailed configuration example of the circuit device according to the present embodiment.

FIG. 10 shows an example of layout design related to diffused resistors and polysilicon resistors.

### DESCRIPTION OF EMBODIMENTS

Hereinafter, preferred embodiments of the present disclosure will be described in detail. The following embodiments do not unduly limit the description in "What is Claimed is", and not all of the configurations described in the embodiments are necessarily essential component elements.

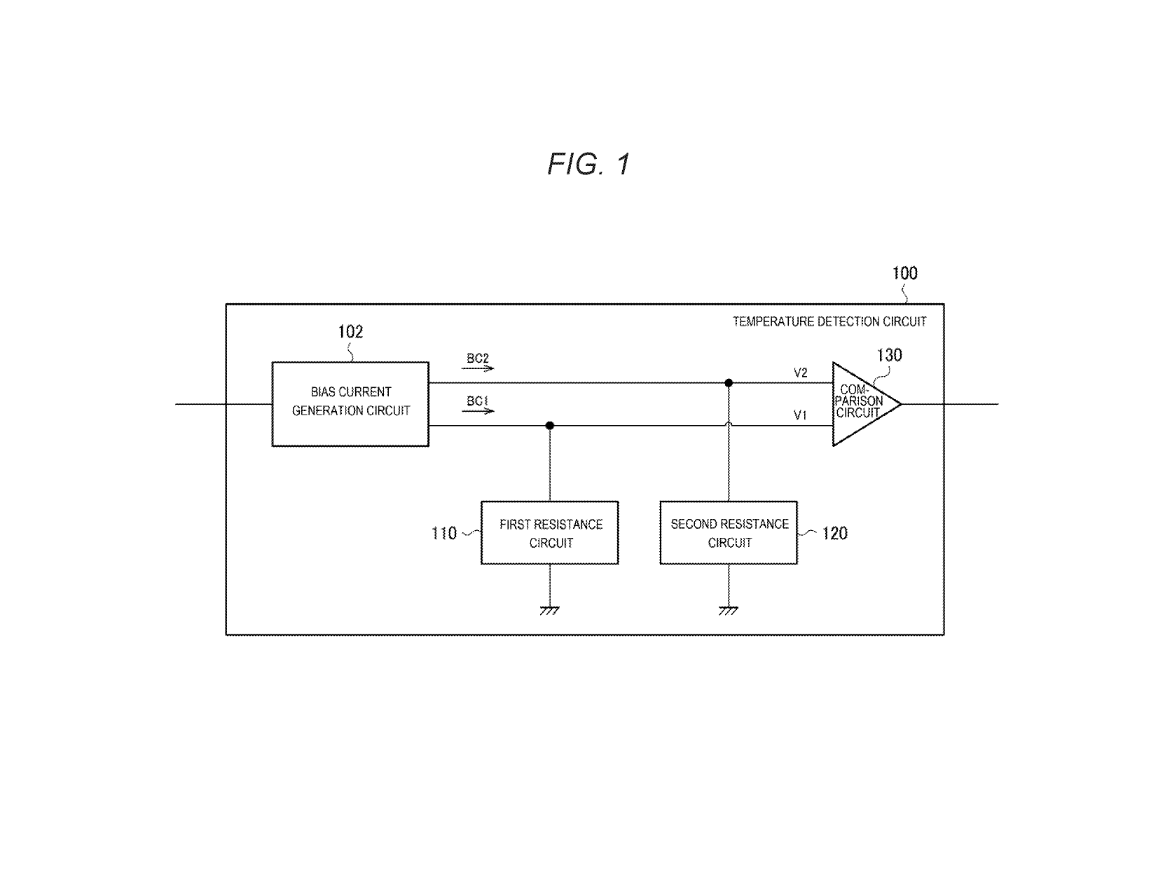

FIG. 1 shows a configuration example of a temperature detection circuit 100 of the present embodiment. The temperature detection circuit 100 includes a bias current generation circuit 102, a first resistance circuit 110, a second resistance circuit 120, and a comparison circuit 130.

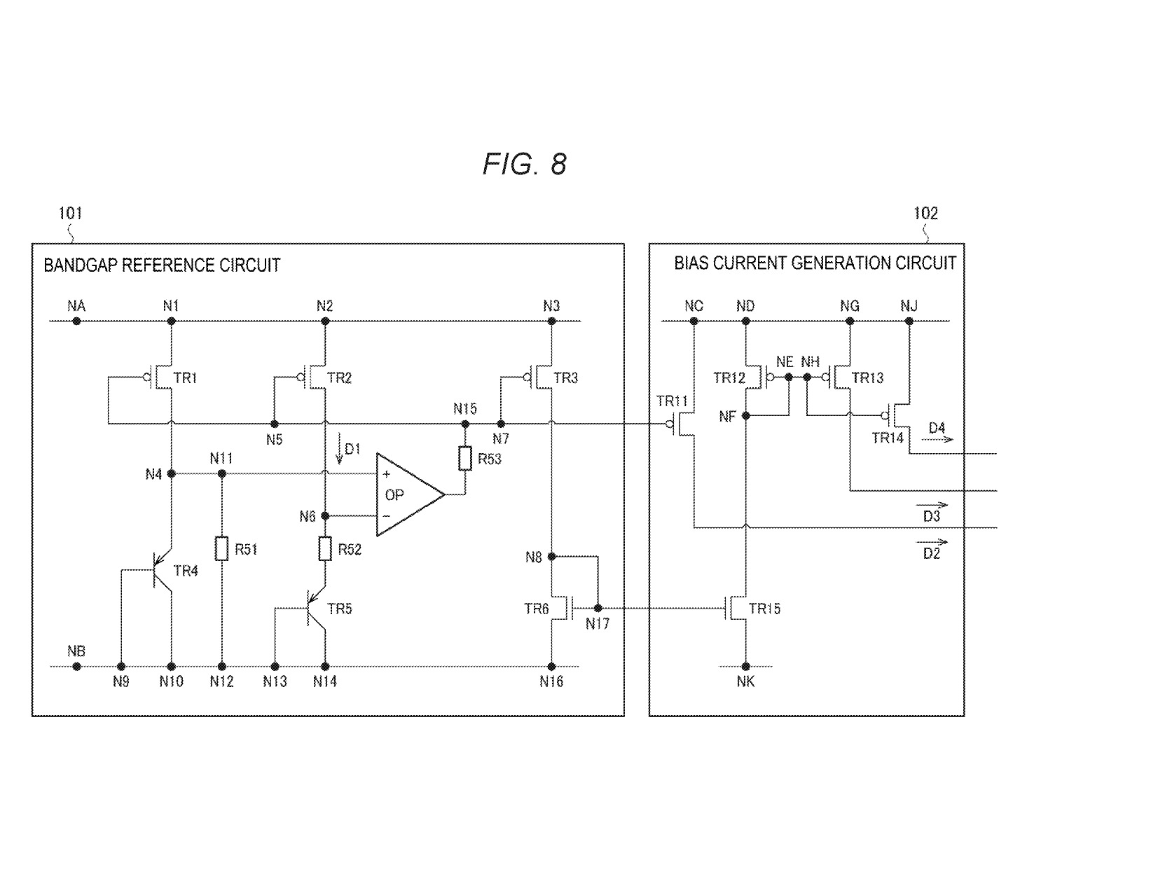

Although the details will be described later, the bias current generation circuit 102 generates a first bias current BC1 and a second bias current BC2 based on a predetermined current source. The predetermined current source may be any current source, for example, a current source having a positive or negative temperature characteristic or a current source having no temperature characteristic. The generated first bias current BC1 and second bias current BC2 may have positive or negative temperature characteristics or not. The bias current generation circuit 102 may generate the first bias current BC1 and the second bias current BC2 by mirroring the internal current of the bandgap reference circuit 101 as will be described later with reference to FIG. 8. In this case, a transistor for the internal current of the bandgap reference circuit 101 to flow is a component element corresponding to the predetermined current source.

One input node of the comparison circuit 130 and one end of the first resistance circuit 110 are coupled to the output node of the first bias current BC1. Accordingly, a first voltage V1 generated by the first bias current BC1 flowing through the first resistance circuit 110 is input to the one input node of the comparison circuit 130. Hereinafter, the temperature characteristic of the first voltage V1 is referred to as a first voltage-temperature characteristic. The first voltage-temperature characteristic relates to the configuration of the first resistance circuit 110 as will be described later.

The other input node of the comparison circuit 130 and one end of the second resistance circuit 120 are coupled to the output node of the second bias current BC2. Accordingly, a second voltage V2 generated by the second bias current BC2 flowing through the second resistance circuit 120 is input to the other input node of the comparison circuit 130. Hereinafter, the temperature characteristic of the second voltage V2 is referred to as a second voltage-temperature characteristic. The second voltage-temperature characteristic relates to the configuration of the second resistance circuit 120 as will be described later.

Although not illustrated in FIG. 1, a predetermined line coupling the bias current generation circuit 102 and the bias input node of the comparison circuit 130 may present, and the bias current generation circuit 102 may supply a bias current to the comparison circuit 130 via the bias current node.

Although the detailed configuration is well known and not illustrated, the comparison circuit 130 compares the first voltage V1 having the first voltage-temperature characteristic with the second voltage V2 having the second voltage-temperature characteristic, and outputs the comparison result as a temperature detection signal. Although the details will be described later, in the present embodiment, the first voltage-temperature characteristic and the second voltage-temperature characteristic are set to be different from each other. The first voltage-temperature characteristic and the second voltage-temperature characteristic are different from each other, more specifically, in graphical representation of the temperature dependence the first voltage V1 and the second voltage V2, the gradients of the graphs are different. Therefore, the graphs intersect at a predetermined temperature.

For example, it is assumed that the first voltage V1 is input to the negative input node of the comparison circuit 130 and the second voltage V2 is input to the positive input node. In this case, when the temperature around the temperature detection circuit 100 is lower than the predetermined temperature, the first voltage V1 input to the comparison circuit 130 is higher than the second voltage V2, and the comparison circuit 130 outputs, for example, a low-level detection signal. In contrast, when the temperature around the temperature detection circuit 100 is equal to or higher than the predetermined temperature, the second voltage V2 input to the comparison circuit 130 is higher than the first voltage V1, and thus the comparison circuit 130 outputs, for example, a high-level detection signal. In this case, the change of the low-level detection signal output from the comparison circuit 130 to the high-level detection signal indicates that the temperature has reached the predetermined temperature. The first voltage V1 may be input to the positive input node of the comparison circuit 130, and the second voltage V2 may be input to the negative input node. In this case, when the first voltage V1 input to the comparison circuit 130 is higher than the second voltage V2, a high-level detection signal is output from the comparison circuit 130, and when the second voltage V2 input to the comparison circuit 130 is higher than the first voltage V1, a low-level detection signal is output. Therefore, the user sets a desired temperature as a detection target temperature TD and sets the first voltage-temperature characteristic and the second voltage-temperature characteristic so that the temperature related to the intersection of the first voltage-temperature characteristic and the second voltage-temperature characteristic becomes the detection target temperature TD, thereby constructing the temperature detection circuit 100 indicating that the ambient temperature has reached the detection target temperature TD.

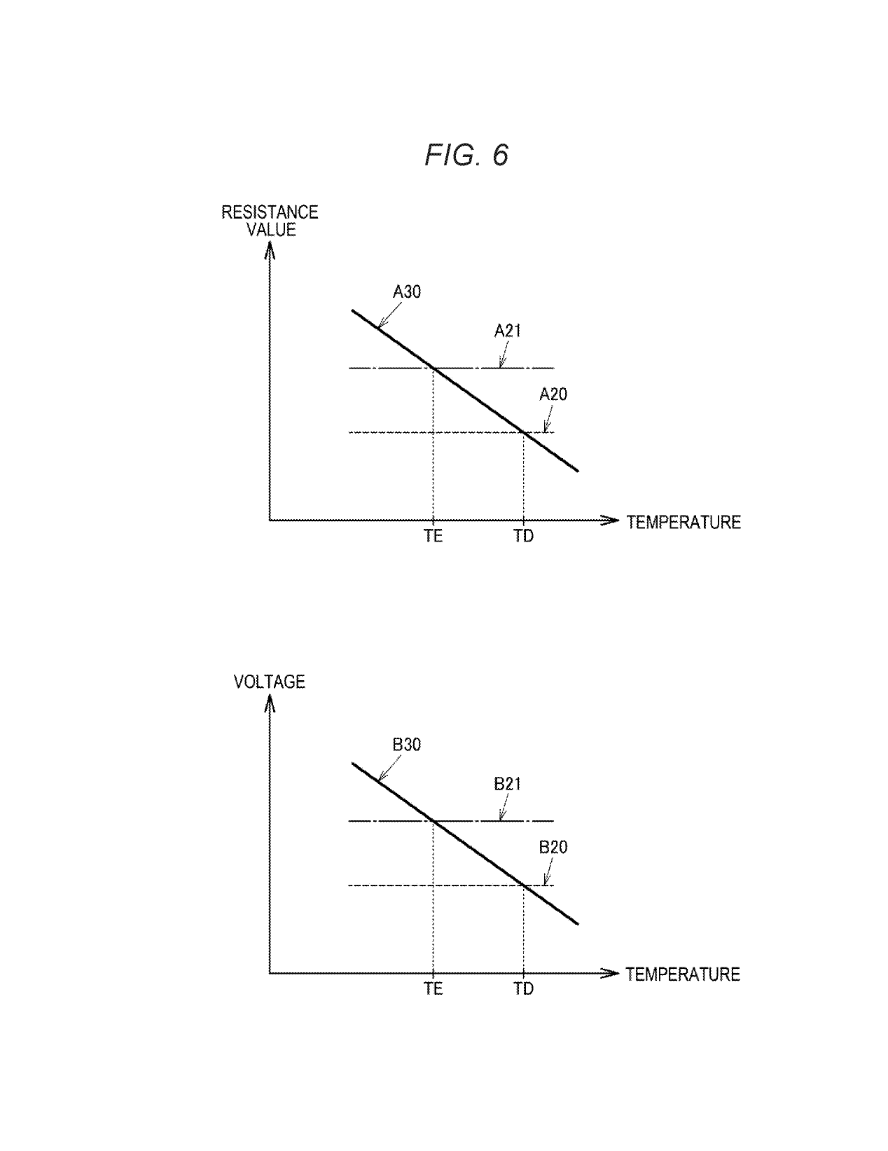

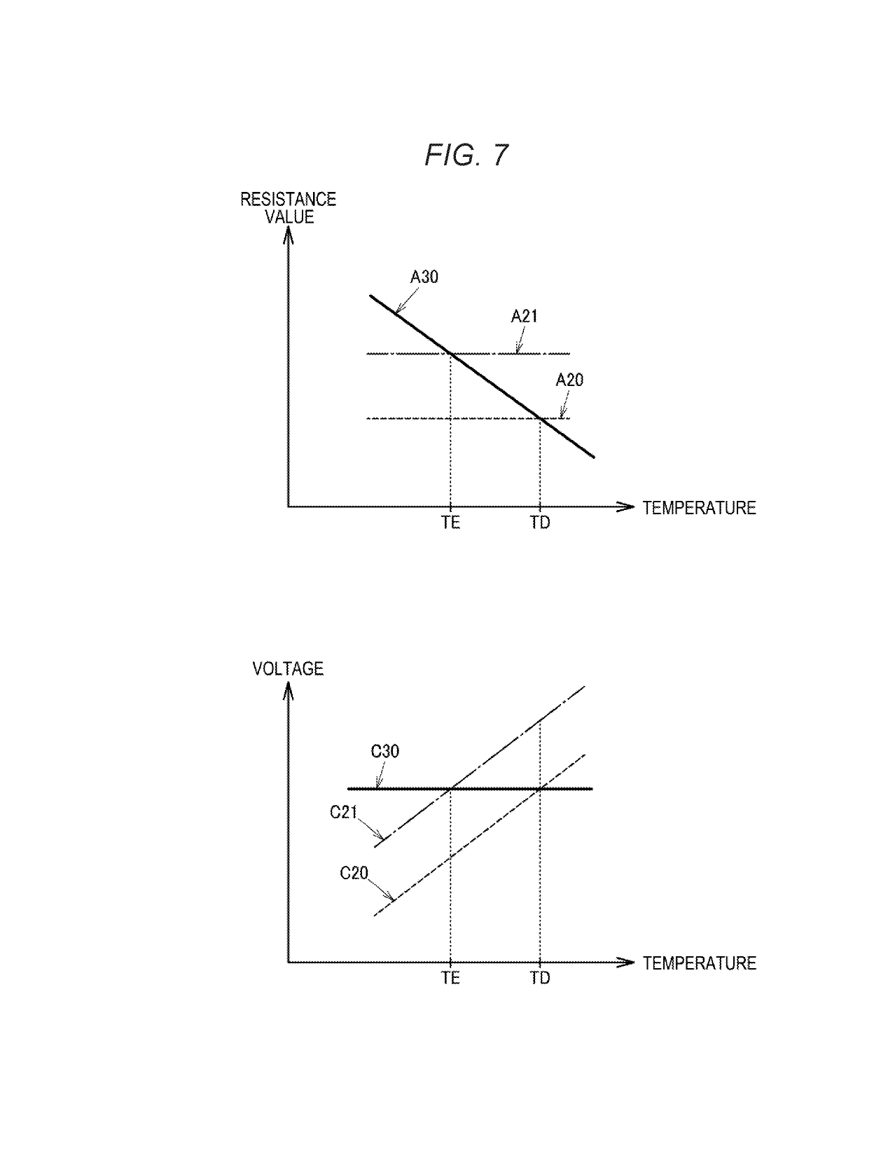

Although more specific examples of the first voltage-temperature characteristic and the second voltage-temperature characteristic will be described later with reference to FIGS. 6 and 7, the present disclosure is not limited thereto as long as the first voltage-temperature characteristic and the second voltage-temperature characteristic are different from each other. For example, when a current-temperature characteristic of the first bias current BC1 and a current-temperature characteristic of the second bias current BC2 are the same, the first voltage-temperature characteristic and the second voltage-temperature characteristic can be made different by making a first resistance-temperature characteristic as a temperature characteristic of the first resistance circuit 110 different from a second resistance-temperature characteristic as a temperature characteristic of the second resistance circuit 120 by a method described later. Furthermore, when the current-temperature characteristic of the first bias current BC1 and the current-temperature characteristic of the second bias current BC2 are the same, the temperature related to the intersection of the first resistance-temperature characteristic and the second resistance-temperature characteristic is the detection target temperature TD. For example, as will be described later, the bias current generation circuit 102 includes a plurality of current mirror circuits, and the same current is mirrored by the plurality of current mirror circuits to generate the first bias current BC1 and the second bias current BC2, so that the current-temperature characteristic of the first bias current BC1 and the current-temperature characteristic of the second bias current BC2 can be made the same. When the first voltage-temperature characteristic and the second voltage-temperature characteristic are different, the current-temperature characteristic of the first bias current BC1 and the current-temperature characteristic of the second bias current BC2 may be different.

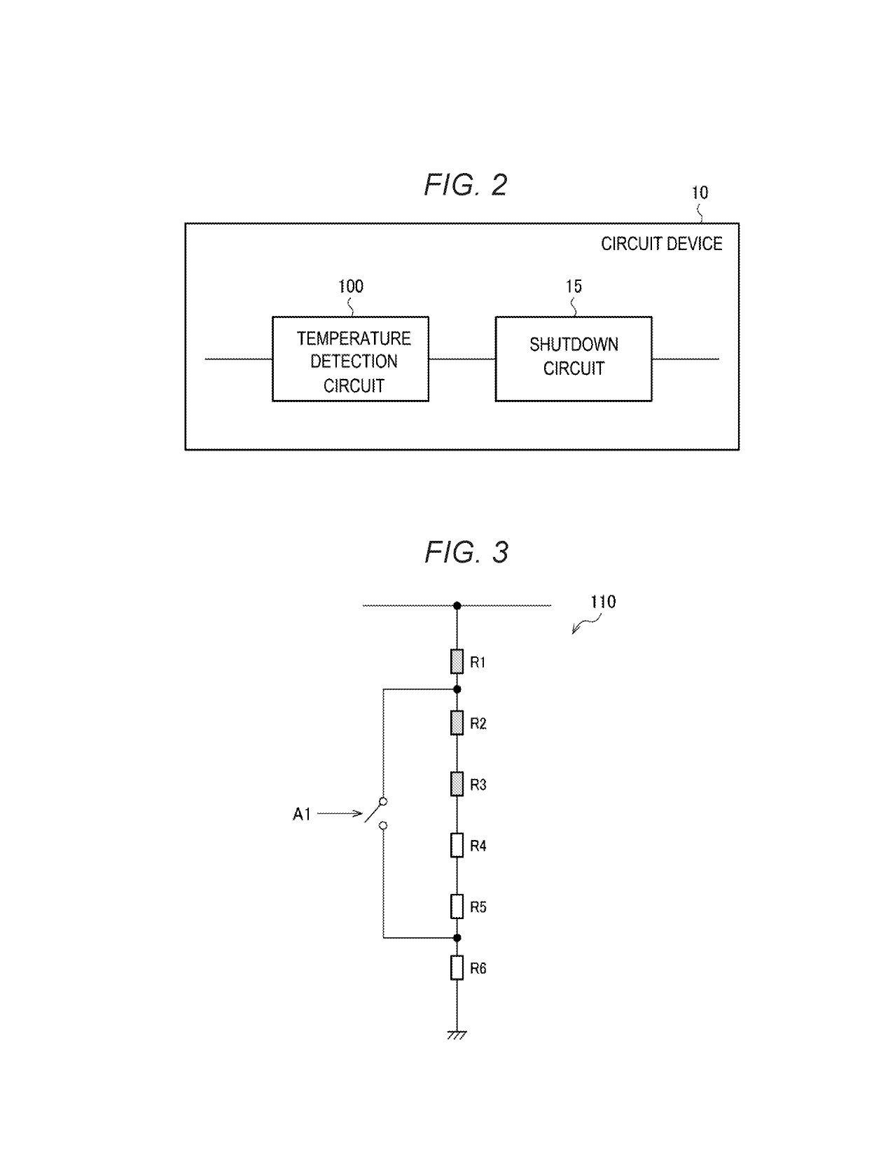

The temperature detection circuit 100 configured as described above can be applied to, for example, a circuit device 10 illustrated in FIG. 2. The circuit device 10 includes the temperature detection circuit 100 and a shutdown circuit 15. The shutdown circuit 15 performs a shutdown operation of the circuit device 10 when a detection signal indicating that the temperature has reached the detection target temperature TD is output. For example, although not illustrated, the shutdown circuit 15 includes a switch including a transistor or the like, and controls on and off according to a change in the detection signal output from the comparison circuit 130. For example, when the ambient temperature of the temperature detection circuit 100 reaches the detection target temperature TD and the detection signal output from the comparison circuit 130 changes, the switch is switched from off to on, and a predetermined signal for setting a shutdown mode is output to a predetermined circuit (not illustrated) to be shut down. As a result, the predetermined circuit is in the shutdown mode while receiving the predetermined signal, and for example, can be in a state of not accepting a desired input.

As described above, the temperature detection circuit 100 of the present embodiment includes the bias current generation circuit 102 that generates the first bias current BC1 and the second bias current BC2, the first resistance circuit 110 through which the first bias current BC1 flows, the second resistance circuit 120 through which the second bias current BC2 flows, and the comparison circuit 130. The comparison circuit 130 compares the first voltage V1 generated by the first bias current BC1 flowing through the first resistance circuit 110 with the second voltage V2 generated by the second bias current BC2 flowing through the second resistance circuit 120 and having the second voltage-temperature characteristic different from the first voltage-temperature characteristic of the first voltage V1, and outputs the comparison result as a temperature detection signal.

As described above, since the temperature detection circuit 100 of the present embodiment includes the bias current generation circuit 102, the first resistance circuit 110, the second resistance circuit 120, and the comparison circuit 130, it is possible to construct the temperature detection circuit 100 that compares the first voltage V1 with the second voltage V2 and outputs the comparison result as a temperature detection signal. Furthermore, since the first voltage-temperature characteristic as the temperature characteristic of the first voltage V1 generated by the first bias current BC1 flowing through the first resistance circuit 110 is different from the second voltage-temperature characteristic as the temperature characteristic of the second voltage V2 generated by the second bias current BC2 flowing through the second resistance circuit 120, the comparison result can be made different at a desired temperature with a simpler circuit configuration.

The method of the present embodiment may be implemented as the circuit device 10. That is, the circuit device 10 of the present embodiment includes the temperature detection circuit 100 described above and the shutdown circuit 15 that performs the shutdown operation of the circuit device 10 when the detection signal indicating that the temperature has reached the detection target temperature TD is output. According to the configuration, it is possible to construct the circuit device 10 that performs the shutdown operation based on the detection signal output from the temperature detection circuit 100 that exhibits the above-described effects.

The first voltage-temperature characteristic and the second voltage-temperature characteristic may intersect at the detection target temperature TD. According to the configuration, the detection signal output from the comparison circuit 130 can be made different at the detection target temperature TD, and thus the temperature detection circuit 100 that detects the detection target temperature TD can be constructed.

The resistance value of the first resistance circuit 110 may have the first resistance-temperature characteristic, and the resistance value of the second resistance circuit 120 may have the second resistance-temperature characteristic different from the first resistance-temperature characteristic. According to the configuration, the first voltage-temperature characteristic and the second voltage-temperature characteristic can be made different from each other.

The first resistance circuit 110 and the second resistance circuit 120 will be described in more detail with reference to FIGS. 3, 4, and 5. In the temperature detection circuit 100 of the present embodiment, the first resistance circuit 110 includes a resistor having a positive temperature characteristic and a resistor having a negative temperature characteristic, and the second resistance circuit 120 includes a resistor having a positive or negative temperature characteristic. According to the configuration, the first resistance-temperature characteristic and the second resistance-temperature characteristic can be made different from each other.

The first resistance-temperature characteristic is set to be flat by the first resistance circuit 110 configured as described above. The flat first resistance-temperature characteristic refers to that the resistance value of the first resistance circuit 110 is the same value without depending on the temperature change. However, even when the resistance value of the first resistance circuit 110 is slightly varied in a desired temperature range, but can be treated as being not substantially varied, the first resistance-temperature characteristic may be treated as being flat. More specifically, for example, the ratio of the resistance having the positive temperature characteristic and the ratio of the resistance having the negative temperature characteristic are determined such that the temperature characteristic of the combined resistance of the resistance contained in the first resistance circuit 110 and having the positive temperature characteristic and the resistance contained in the first resistance circuit 110 and having the negative temperature characteristic becomes flat. As long as the second resistance-temperature characteristic may be different from the first resistance-temperature characteristic, the second resistance-temperature characteristic may be positive or negative, and may be appropriately determined. From the above, in the temperature detection circuit 100 of the present embodiment, the first resistance-temperature characteristic is the flat temperature characteristic, and the second resistance-temperature characteristic is the positive or negative temperature characteristic. According to the configuration, the intersection of the first resistance-temperature characteristic and the second resistance-temperature characteristic can be easily set. This is because when the resistance value related to the first resistance-temperature characteristic can be made constant, a desired detection target temperature TD can be set only by adjusting the second resistance-temperature characteristic. Accordingly, it is possible to easily set the detection target temperature TD and a test temperature TE to be described later.

The resistor having the positive temperature characteristic is, for example, a diffusion resistor using, as a resistor, a diffusion region formed on a silicon substrate by implanting a relatively high-concentration impurity, but is not limited thereto, and may be another resistor such as a well resistor. The resistor having the negative temperature characteristic is, for example, a polysilicon resistor formed of a polysilicon layer, but may be another resistor. Here, the polysilicon resistor is not limited to a polysilicon resistor formed of a pure polysilicon layer, and includes a polysilicon resistor doped with a P-type impurity and a polysilicon resistor doped with an N-type impurity, and hereinafter, these are collectively and simply referred to as a polysilicon resistor.

Hereinafter, a diffusion resistor is exemplified as a resistor having a positive resistance-temperature characteristic, and a polysilicon resistor is exemplified as a resistor having a negative resistance-temperature characteristic. That is, in the temperature detection circuit 100 of the present embodiment, the first resistance circuit 110 includes a polysilicon resistor and a diffusion resistor, and the second resistance circuit 120 includes a polysilicon resistor or a diffusion resistor. According to the configuration, the temperature detection circuit 100 including the first resistance circuit 110 and the second resistance circuit 120 using the polysilicon resistor and the diffusion resistor can be constructed.

Also, when the first resistance circuit 110 is configured as described above, the first resistance-temperature characteristic is flat. That is, in the temperature detection circuit 100 of the present embodiment, in the first resistance circuit 110, the resistance ratio between the polysilicon resistor and the diffusion resistor is a resistance ratio at which the first resistance-temperature characteristic becomes a flat temperature characteristic. According to the configuration, the first resistance circuit 110 having the flat temperature characteristic can be constructed using the polysilicon resistor having the negative temperature characteristic and the diffusion resistor having the positive temperature characteristic.

In addition, the resistor having the positive temperature characteristic contained in the first resistance circuit 110 may be a single diffusion resistor, or may include a plurality of unit resistors. Similarly, the resistor having the negative temperature characteristic contained in the first resistance circuit 110 may be a single polysilicon resistor or may include a plurality of unit resistors. A specific configuration example of the first resistance circuit 110 will be described with reference to FIG. 3.

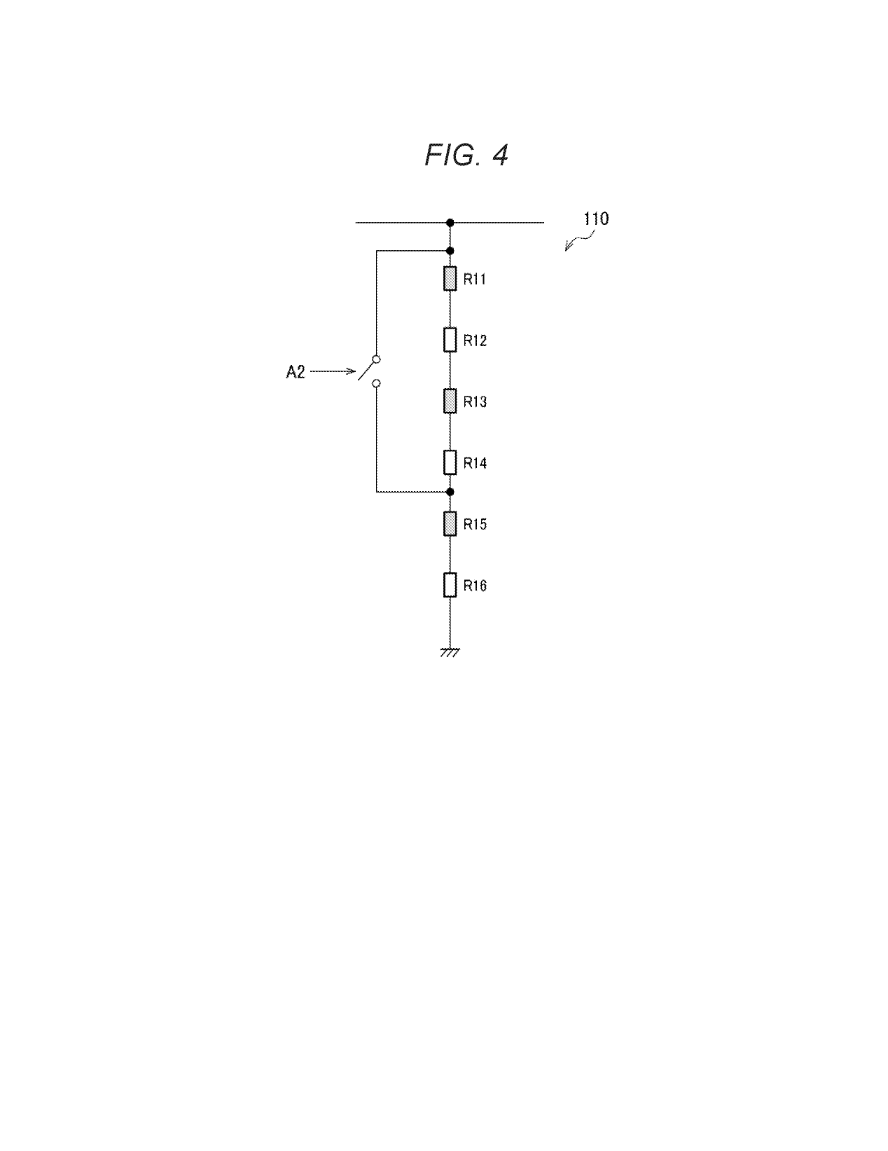

In FIG. 3, the first resistance circuit 110 includes resistors R1, R2, R3, R4, R5, and R6, and the resistors R1 to R6 are coupled in series. More specifically, one end of the resistor R1 is coupled to the output node of the first bias current BC1, and the other end is coupled to one end of the resistor R2. The other end of the resistor R2 is coupled to one end of the resistor R3, the other end of the resistor R3 is coupled to one end of the resistor R4, the other end of the resistor R4 is coupled to one end of the resistor R5, the other end of the resistor R5 is coupled to one end of the resistor R6, and the other end of the resistor R6 is coupled to a node coupled to the ground. Hereinafter, the node coupled to the ground is referred to as a ground node. In FIG. 3, the other end of the resistor R6 is illustrated to be coupled to the ground node, but may be coupled to another node as long as the node has a constant voltage. The same applies to the other end of a resistor R16 in FIG. 4 described later.

In FIG. 3, each of the resistors R1 to R3 is a diffusion resistor as a first unit resistor, and the resistors R1 to R3 are coupled in series. In FIG. 3, each of the resistors R4 to R6 is a polysilicon resistor as a second unit resistor, and the resistors R4 to R6 are coupled in series. Note that FIG. 3 shows an example, and the number of the first units is not limited to three, and can be generalized to n. Similarly, the number of the second unit resistors is not limited to three, and can be generalized to n. Note that n is an integer of 2 or more. However, the first temperature characteristic is flat regardless of the number of n.

Although FIG. 3 illustrates that the second resistor unit is coupled to the ground node side, the first resistor unit may be coupled to the ground node side.

In addition, when the first resistance circuit 110 is configured with the resistance having the positive temperature characteristic as the first unit resistance and the resistance having the negative temperature characteristic as the second unit resistance, for example, the value of the combined resistance of the first resistance circuit 110 may be changed by switch control. Specifically, for example, the first resistance circuit 110 may further include a switch indicated by A1 in FIG. 3. In FIG. 3, a circuit including the resistor R2 and the resistor R3 as the two first unit resistors and the resistor R4 and the resistor R5 as the two second unit resistors and the switch indicated by A1 are coupled in parallel. The numbers of the first unit resistors and the second unit resistors coupled in parallel to the switch indicated by A1 are not limited to two, and can be generalized to k. k is an integer of 1 or more and less than n. When the switch indicated by A1 is off, the resistance value of the combined resistor of the first resistance circuit 110 is the sum of the resistance values of the resistors R1 to R6. In contrast, when the switch indicated by A1 is on, the first bias current BC1 does not substantially flow through the circuit including the resistors R2 to R5, and thus the resistance value of the combined resistor of the first resistance circuit 110 is the sum of the resistance value of the resistor R1 and the resistance value of the resistor R6. As described above, the first resistance circuit 110 includes the switch indicated by A1, so that the resistance value of the combined resistance of the first resistance circuit 110 can be changed. Even when the resistance value of the combined resistance of the first resistance circuit 110 is changed, the first resistance-temperature characteristic is flat.

The switch indicated by A1 in FIG. 3 can be used, for example, as a switch in a test mode for testing the temperature detection circuit 100. The test here is, for example, a test at the time of shipment of a product related to the circuit device 10 including the temperature detection circuit 100, but may be another test. A mode other than the test mode is referred to as a normal mode. Since the position of the intersection of the first resistance-temperature characteristic and the second resistance-temperature characteristic changes by changing the resistance value of the combined resistance of the first resistance circuit 110, the first resistance-temperature characteristic and the second resistance-temperature characteristic can intersect at two different temperatures. Therefore, as will be described later in detail with reference to FIG. 6 and the like, the switch indicated by A1 may be turned on and off such that the higher temperature related to the intersection is the detection target temperature TD and the lower temperature related to the intersection is the test temperature TE. From the above, in the temperature detection circuit 100 of the present embodiment, the first resistance circuit 110 includes a switch for the test mode, and the switch is coupled in parallel to the k first unit resistors (k is an integer of 1 or more and less than n) and the k second unit resistors. According to the configuration, the resistance value of the first resistance circuit 110 can be changed, and thus the first resistance-temperature characteristic and the second resistance-temperature characteristic can be made to intersect at a lower temperature in the test mode. That is, in the test mode, the intersection of the first voltage-temperature characteristic and the second voltage-temperature characteristic can be tested at a lower temperature.

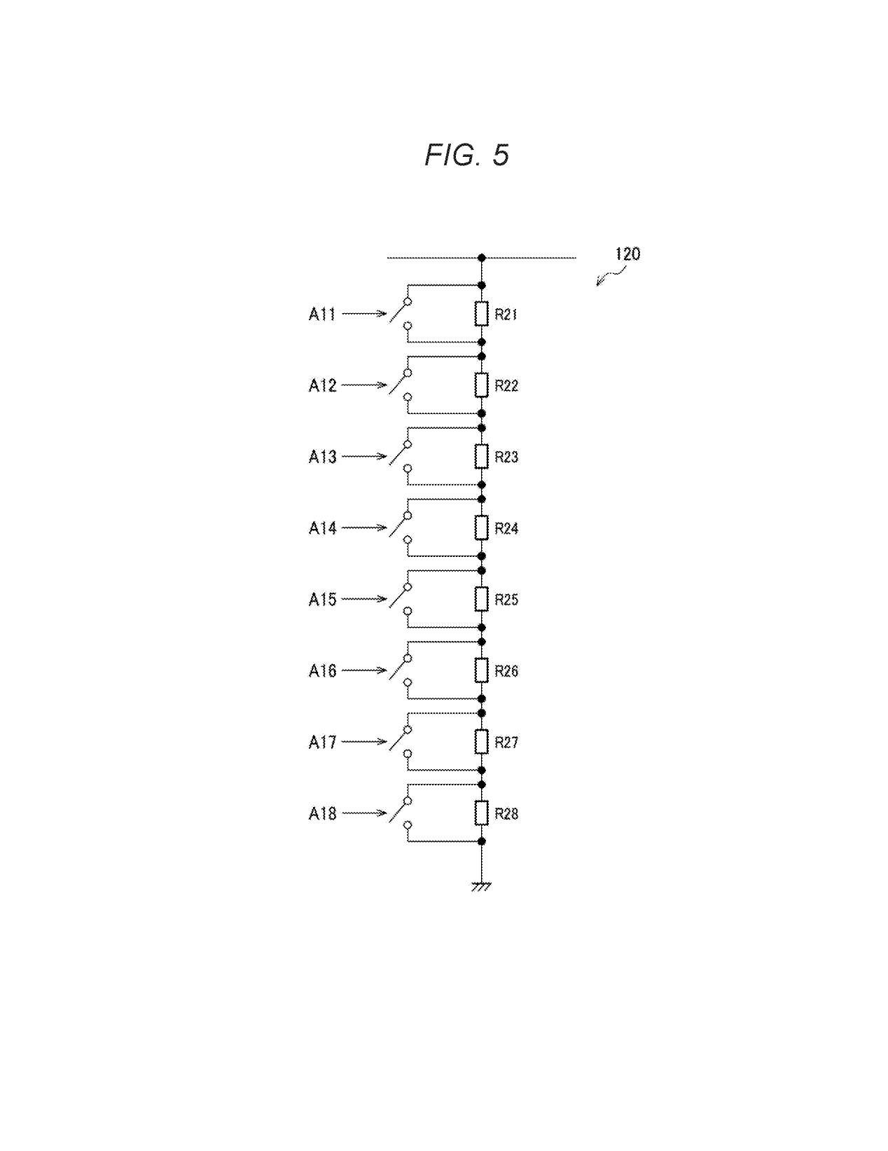

The switch indicated by A1 in FIG. 3 is illustrated for convenience, and the on/off of the switch indicated by A1 may be implemented as electrical on/off using a transistor. The same applies to a switch indicated by A2 described later in FIG. 4 and switches indicated by A11, A12, A13, A14, A15, A16, A17, and A18 described later in FIG. 5. In addition, although not illustrated, in a semiconductor package including the circuit device 10 containing the temperature detection circuit 100, there is an external terminal for enabling a test device or the like to switch between the normal mode and the test mode. Alternatively, the circuit device 10 containing the temperature detection circuit 100 may include a register circuit accessed by a test device or the like for switching between the normal mode and the test mode.

The first resistance circuit 110 of the present embodiment may be configured as in a configuration example shown in FIG. 4, for example. In FIG. 4, the first resistance circuit 110 includes the resistors R11, R12, R13, R14, R15, and R16, and the resistors R11 to R16 are coupled in series. More specifically, for example, one end of the resistor R11 is coupled to the output node of the first bias current BC1, and the other end is coupled to one end of the resistor R12. The other end of the resistor R12 is coupled to one end of the resistor R13, the other end of the resistor R13 is coupled to one end of the resistor R14, the other end of the resistor R14 is coupled to one end of the resistor R15, the other end of the resistor R15 is coupled to one end of the resistor R16, and the other end of the resistor R16 is coupled to the ground node. Here, each of the resistor R11, the resistor R13, and the resistor R15 is a first unit resistor, and is, for example, a diffusion resistor having a positive temperature characteristic. Each of the resistor R12, the resistor R14, and the resistor R16 is a second unit resistor, and is, for example, a polysilicon resistor having a negative temperature characteristic. That is, FIG. 4 is different from FIG. 3 in that a resistor having a positive resistance-temperature characteristic and a resistor having a negative resistance-temperature characteristic are alternately coupled in series. However, in FIG. 4, the resistance value of the combined resistance of the first resistance circuit 110 is the sum of the resistance values of the resistors R11 to R16, and the resistors R11 to R16 are set such that the temperature characteristic of the combined resistance of the first resistance circuit 110 is flat similar to FIG. 3. Also in the example of FIG. 4, the value of the combined resistance of the first resistance circuit 110 may be changed by, for example, switch control. Specifically, for example, the first resistance circuit 110 may further include a switch indicated by A2 in FIG. 4. Accordingly, when the switch indicated by A2 is off, the resistance value of the combined resistor of the first resistance circuit 110 is the sum of the resistance values of the resistors R11 to R16, and when the switch indicated by A2 is on, the resistance value of the combined resistor of the first resistance circuit 110 is the sum of the resistance value of the resistor R15 and the resistance value of the resistor R16, and the resistance value of the combined resistor of the first resistance circuit 110 can be changed. Also in the example of FIG. 4, it is assumed that the first resistance-temperature characteristic remains flat even when the resistance value of the combined resistance of the first resistance circuit 110 is changed. As described above, in the temperature detection circuit 100 of the present embodiment, the diffusion resistance of the first resistance circuit 110 includes n first unit resistances (n is an integer of 2 or more), the polysilicon resistance of the first resistance circuit 110 includes n second unit resistances, the n first unit resistances and the n second unit resistances are coupled in series, and the resistance ratio of the first unit resistance and the second unit resistance is the same as the resistance ratio of the polysilicon resistance and the diffusion resistance. According to the configuration, the first resistance circuit 110 having the flat first temperature characteristic can be constructed by the first unit resistance and the second unit resistance.

FIG. 5 shows a configuration example of the second resistance circuit 120. In FIG. 5, the second resistance circuit 120 includes resistors R21, R22, R23, R24, R25, R26, R27, and R28, and the resistors R21 to R28 are coupled in series. More specifically, for example, one end of the resistor R21 is coupled to the output node of the second bias current BC2, and the other end is coupled to one end of the resistor R22. The other end of the resistor R22 is coupled to one end of the resistor R23, the other end of the resistor R23 is coupled to one end of the resistor R24, the other end of the resistor R24 is coupled to one end of the resistor R25, the other end of the resistor R25 is coupled to one end of the resistor R26, the other end of the resistor R26 is coupled to one end of the resistor R27, the other end of the resistor R27 is coupled to one end of the resistor R28, and the other end of the resistor R28 is coupled to the ground node.

The resistors R21 to R28 illustrated in FIG. 5 are all polysilicon resistors having negative resistance-temperature characteristics, and the description of FIGS. 6 and 7 described later is based on this. However, as described above, as long as the first resistance-temperature characteristic and the second resistance-temperature characteristic may be different from each other, the resistors R21 to R28 may be diffusion resistors having positive resistance-temperature characteristics.

The second resistance circuit 120 may be a variable resistance circuit. Specifically, the second resistance circuit 120 can operate as a variable resistance circuit by further including the switches indicated by A11 to A18. When all the switches indicated by A11 to A18 are off, the resistance value of the combined resistor of the second resistance circuit 120 is the sum of the resistance values of the resistors R21 to R28. When only the switch indicated by A11 is on, the resistance value of the combined resistor of the second resistance circuit 120 is the sum of the resistance values of the resistors R22 to R28. When only the switch indicated by A12 is on, the resistance value of the combined resistor of the second resistance circuit 120 is the sum of the resistance values of the resistor R21 and the resistors R23 to R28. When only the switch indicated by A13 is on, the resistance value of the combined resistor of the second resistance circuit 120 is the sum of the resistance values of the resistors R21, R22, and R24 to R28. When only the switch indicated by A14 is on, the resistance value of the combined resistor of the second resistance circuit 120 is the sum of the resistance values of the resistors R21 to R23 and the resistors R25 to R28. When only the switch indicated by A15 is on, the resistance value of the combined resistor of the second resistance circuit 120 is the sum of the resistance values of the resistors R21 to R24 and the resistors R26 to R28. When only the switch indicated by A16 is on, the resistance value of the combined resistor of the second resistance circuit 120 is the sum of the resistance values of the resistors R21 to R25, R27, and R28. When only the switch indicated by A17 is on, the resistance value of the combined resistor of the second resistance circuit 120 is the sum of the resistance values of the resistors R21 to R26 and the resistor R28. When only the switch indicated by A18 is on, the resistance value of the combined resistor of the second resistance circuit 120 is the sum of the resistance values of the resistors R21 to R27.

Although the detailed description is omitted, two or more switches among the switches indicated by A11 to A18 may be turned on, and a combination of switches to be turned on may be appropriately determined. For example, the temperature detection circuit 100 includes a trimming circuit (not illustrated in FIG. 5). The trimming circuit includes, for example, a nonvolatile memory or the like, refers to a trimming value stored in the nonvolatile memory, and outputs a signal for controlling on/off of the switches indicated by A11 to A18 so as to correspond to a desired trimming value. Thus, the resistance value of the second resistance circuit 120 can be variably controlled by the trimming value. In other words, in the graph of the resistance-temperature characteristic in which the vertical axis indicates the resistance value and the horizontal axis indicates the temperature, the value of the intercept of the second resistance-temperature characteristic can be variably controlled by the trimming value. Since the second voltage-temperature characteristic is determined based on the second resistance-temperature characteristic, the second voltage-temperature characteristic is variably controlled by the trimming value. Accordingly, the temperature at which the first voltage-temperature characteristic and the second voltage-temperature characteristic intersect can be adjusted by the trimming value.

As described above, in the temperature detection circuit 100 of the present embodiment, the second resistance circuit 120 is a variable resistance circuit in which the resistance value is set by the trimming value, and the trimming value is set such that the first voltage-temperature characteristic and the second voltage-temperature characteristic intersect at the detection target temperature TD. This makes it easy to adjust the detection target temperature TD in consideration of manufacturing variations. Specifically, for example, since there are manufacturing variations of a wafer related to the temperature detection circuit 100, the first resistance-temperature characteristic, the second resistance-temperature characteristic, and the data of the detection target temperature TD related to the intersection thereof do not necessarily match the design data, and adjustment is necessary after manufacturing. In this case, it is more convenient to adjust the detection target temperature TD by fixing the first temperature characteristic and changing the second temperature characteristic than to adjust the detection target temperature TD by fixing the second temperature characteristic and changing the first temperature characteristic. This is because, as described above, the first resistance circuit 110 includes the polysilicon resistor and the diffusion resistor, whereas the second resistance circuit 120 includes only the polysilicon resistor or only the diffusion resistor.

The upper diagram of FIG. 6 shows an example of the relationship between the first resistance-temperature characteristic and the second resistance-temperature characteristic. When the temperature detection circuit 100 is operated in the normal mode, the first resistance-temperature characteristic is as indicated by A20, and the second resistance-temperature characteristic is as indicated by A30. The temperature related to the intersection of the first resistance-temperature characteristic indicated by A20 and the second resistance-temperature characteristic indicated by A30 is the detection target temperature TD. For example, when the temperature characteristics of the first bias current BC1 and the second bias current BC2 output by the bias current generation circuit 102 are flat, the relationship between the first voltage-temperature characteristic and the second voltage-temperature characteristic is illustrated in the lower diagram of FIG. 6. When the temperature detection circuit 100 is operated in the normal mode, the first voltage-temperature characteristic is as indicated by B20, and the second voltage-temperature characteristic is as indicated by B30. The temperature related to the intersection of the first voltage-temperature characteristic indicated by B20 and the second voltage-temperature characteristic indicated by B30 is the detection target temperature TD. That is, when the temperature around the temperature detection circuit 100 is lower than the detection target temperature TD, the second voltage V2 is higher than the first voltage V1, and when the temperature around the temperature detection circuit 100 is equal to or higher than the detection target temperature TD, the second voltage V2 is lower than the first voltage V1. As a result, when the second voltage V2 becomes lower than the first voltage V1, the detection signal output from the comparison circuit 130 changes.

When the temperature detection circuit 100 is operated in the test mode, the value of the combined resistance of the first resistance circuit 110 increases, and thus the first resistance-temperature characteristic is as indicated by A21. The temperature related to the intersection of the first resistance-temperature characteristic indicated by A21 and the second resistance-temperature characteristic indicated by A30 is the test temperature TE. The test temperature TE is lower than the detection target temperature TD. When the temperature detection circuit 100 is operated in the test mode, the first voltage-temperature characteristic is as indicated by B21. The temperature related to the intersection of the first voltage-temperature characteristic indicated by B21 and the second voltage-temperature characteristic indicated by B30 is the test temperature TE. Since the first resistance-temperature characteristic is a negative temperature characteristic and the second resistance-temperature characteristic is flat, the test temperature TE can be made lower than the detection target temperature TD by increasing the combined resistance of the first resistance circuit 110 in the test mode.

Although FIG. 6 illustrates an example in which the temperature characteristic of the current output by the bias current generation circuit 102 is flat, the current output by the bias current generation circuit 102 may have a temperature characteristic. For example, it is desirable to make the second voltage-temperature characteristic flat by the temperature characteristic of the current output by the bias current generation circuit 102 and the second resistance-temperature characteristic. This is because the intersection of the first voltage-temperature characteristic and the second voltage-temperature characteristic can be easily set.

FIG. 7 shows an example in which the method of the present embodiment is applied to a case where the first bias current BC1 and the second bias current BC2 output by the bias current generation circuit 102 have positive temperature characteristics, for example. Since the upper diagram of FIG. 7 is the same as the upper diagram of FIG. 6, the description thereof will be omitted. In the lower diagram of FIG. 7, when the temperature detection circuit 100 is operated in the normal mode, the first voltage-temperature characteristic is as indicated by C20, the second voltage-temperature characteristic is as indicated by C30, and the temperature related to the intersection of the first voltage-temperature characteristic indicated by C20 and the second voltage-temperature characteristic indicated by C30 is the detection target temperature TD. When the temperature detection circuit 100 is operated in the test mode, the first voltage-temperature characteristic is as indicated by C21, and the temperature related to the intersection of the first voltage-temperature characteristic indicated by C21 and the second voltage-temperature characteristic indicated by C30 is the test temperature TE. As described above, even when the current output by the bias current generation circuit 102 has a temperature characteristic, the method of the present embodiment can be applied.

For example, in the test at the time of shipment of the circuit device 10, the test device sets the temperature detection circuit 100 in the test mode, and monitors the output signal of the comparison circuit 130 while changing the trimming value of the second resistance circuit 120 in a state in which the ambient temperature of the circuit device 10 is set to the test temperature TE. Then, the test device writes the trimming value when the output signal of the comparison circuit 130 is inverted in the trimming circuit described above. As a result, a trimming value that matches the resistance value of the second resistance circuit 120 and the resistance value of the first resistance circuit 110 is obtained. Accordingly, the detection target temperature TD can be set to a desired temperature.

From the above, in the temperature detection circuit 100 of the present embodiment, the first resistance circuit 110 is a variable resistance circuit set to different resistance values in the normal mode and the test mode, and the resistance value of the first resistance circuit 110 is a resistance value corresponding to the test temperature TE lower than the detection target temperature TD in the test mode. Further, in the test mode, the first voltage-temperature characteristic and the second voltage-temperature characteristic are set so as to intersect at the test temperature TE, so that in the normal mode, the trimming value is set so that the first voltage-temperature characteristic and the second voltage-temperature characteristic intersect at the detection target temperature TD. According to the configuration, the circuit device 10 including the temperature detection circuit 100 can be tested in an environment of the test temperature TE lower than the detection target temperature TD. This makes it possible to facilitate testing.

The circuit device 10 of the present embodiment may further include a bandgap reference circuit 101. In this case, for example, as illustrated in FIG. 8, the bias current generation circuit 102 may generate the first bias current BC1 and the second bias current BC2 by mirroring the internal bias current of the bandgap reference circuit 101. FIG. 8 shows a configuration example of the bandgap reference circuit 101 and the bias current generation circuit 102 in this case.

In FIG. 8, the bandgap reference circuit 101 includes a transistor TR1, a transistor TR2, a transistor TR3, a transistor TR4, a transistor TR5, a transistor TR6, a resistor R51, a resistor R52, a resistor R53, and an operational amplifier OP. Although not illustrated in detail, the operational amplifier OP can include, for example, a differential circuit having a differential pair transistor and an output circuit that outputs an output voltage based on a signal from the differential circuit.

The transistor TR1 is a P-type MOS transistor and is provided between a node NA as a high-potential-side power supply node and a node of an inverting input terminal of the operational amplifier OP. More specifically, the node NA is, for example, an output node of a power supply circuit (not illustrated). More specifically, in FIG. 8, the source of the transistor TR1 is coupled to a node N1 as a node having the same potential as the node NA. The drain of the transistor TR1 is coupled to a node N4 as a node of the inverting input terminal of the operational amplifier OP. The gate of the transistor TR1 is coupled to a node N5. The node N5 is a node having the same potential as a node N15. One end of the node N15 is coupled to the other end of the resistor R53 coupled to the output terminal of the operational amplifier OP.

Both the transistor TR2 and the transistor TR3 are P-type MOS transistors, and form a current mirror circuit together with the transistor TR1. The source of the transistor TR2 is coupled to a node N2 as a node having the same potential as the node NA, the gate of the transistor TR2 is coupled to a node N5, and the drain of the transistor TR2 is coupled to the node N6 as a node of the non-inverting input terminal of the operational amplifier OP. The source of the transistor TR3 is coupled to a node N3 as a node having the same potential as the node NA, the drain of the transistor TR3 is coupled to a node N8, and the gate of the transistor TR3 is coupled to a node N7.

The transistor TR4 is a PNP-type bipolar transistor, and a PN junction between the emitter and the base functions as a diode element by short-circuiting between the base and the collector. More specifically, the emitter of the transistor TR4 serves as an anode and is coupled to anode N4 having the same potential as the node of the inverting input terminal of the operational amplifier OP. The collector of the transistor TR4 is coupled to a node N10 as a node having the same potential as a node NB which is a low-potential-side power supply node, and the base of the transistor TR4 is coupled to a node N9 as a node having the same potential as the node NB. More specifically, the node NB is, for example, a ground node, but may be a node having a constant potential.

The transistor TR5 is a PNP-type bipolar transistor, and a PN junction between the emitter and the base functions as a diode element by short-circuiting between the base and the collector. More specifically, the emitter of the transistor TR5 is coupled to the other end of the resistor R52 having one end coupled to the node N6. The node N6 is a node having the same potential as the node of the non-inverting input terminal of the operational amplifier OP. The collector of the transistor TR5 is coupled to a node N14 as a node having the same potential as the node NB, and the base of the transistor TR5 is coupled to a node N13 as a node having the same potential as the node NB.

The resistor R51 is provided between the node of the inverting input terminal of the operational amplifier OP and the low-potential-side power supply node. More specifically, one end of the resistor R51 is coupled to a node N11 having the same potential as the node of the inverting input terminal of the operational amplifier OP, and the other end of the resistor R51 is coupled to a node N12 having the same potential as the node NB.

The transistor TR6 is an N-type MOS transistor and forms a current mirror circuit with a transistor TR15 described later. The drain of the transistor TR6 is coupled to the node N8, the source of the transistor TR6 is coupled to the node N16 as a node having the same potential as the node NB which is the low-potential-side power supply node, and the gate of the transistor TR6 is coupled to a node N17.

As described above, in the bandgap reference circuit 101 of FIG. 8, the transistors TR1 and TR2 are provided between the node NA and the inverting input terminal and the non-inverting input terminal of the operational amplifier OP, and the gates of the transistors TR1 and TR2 are controlled by the output of the operational amplifier OP. According to the configuration, feedback control is performed by virtual grounding of the operational amplifier OP so that the inverting input terminal and the non-inverting input terminal have the same voltage. Accordingly, a current by feedback control flows through the transistor TR4 provided in series with the transistor TR1 and the transistor TR5 provided in series with the transistor TR2, and a reference voltage based on the bandgap voltage can be output.

A current D1 flowing through the transistor TR2 can be expressed by a first predetermined relational expression using the base-emitter voltage of the transistor TR4, the base-emitter voltage difference, the resistance value of the resistor R51, the resistance value of the resistor R52, and the resistance value of the resistor R53. The details of the first predetermined relational expression are well known and omitted. The base-emitter voltage difference refers to a difference between the base-emitter voltage of the transistor TR4 and the base-emitter voltage of the transistor TR5. The base-emitter voltage difference can be expressed by a second predetermined relational expression using the ratio of the emitter areas of the transistor TR4 and the transistor TR5, the Boltzmann constant, the absolute temperature, and the electron charge amount. The details of the second predetermined relational expression are well known and omitted.

The bias current generation circuit 102 includes a transistor TR11, a transistor TR12, a transistor TR13, a transistor TR14, and a transistor TR15.

The transistor TR11 is a P-type MOS transistor, the source of the transistor TR11 is coupled to a node NC as a node having the same potential as the high potential side power supply node, and the gate of the transistor TR11 is coupled to the node N7. As described above, since the transistor TR11 forms the current mirror circuit with the transistors TR1 to TR3, the current flowing through the transistor TR11 is a current obtained by mirroring the current flowing through the transistors TR1 to TR3.

The transistor TR12, the transistor TR13, and the transistor TR14 are all P-type MOS transistors, and form a current mirror circuit. The source of the transistor TR12 is coupled to a node ND as a node having the same potential as the high-potential-side power supply node, the drain of the transistor TR12 is coupled to a node NF, and the gate of the transistor TR12 is coupled to a node NE. The source of the transistor TR13 is coupled to a node NG as a node having the same potential as the high-potential-side power supply node, and the gate of the transistor TR13 is coupled to a node NH having the same potential as the node NE. The source of the transistor TR14 is coupled to a node NJ as a node having the same potential as the high-potential-side power supply node, and the gate of the transistor TR14 is coupled to a node NH having the same potential as the node NE.

The transistor TR15 is an N-type MOS transistor and forms a current mirror circuit with the transistor TR6 described above. The drain of the transistor TR15 is coupled to the node NF, the source of the transistor TR15 is coupled to a node NK as a node having the same potential as the low-potential-side power supply node, and the gate of the transistor TR15 is coupled to the node N17.

The transistor TR2 and the transistor TR3 form a current mirror circuit, the transistor TR6 is coupled in series with the transistor TR3, the transistor TR6 and the transistor TR15 form a current mirror circuit, and the transistor TR12 is coupled in series with the transistor TR15. Therefore, the current flowing through the transistor TR12 is a current obtained by mirroring the current flowing through the transistor TR2. The transistor TR13 and the transistor TR14 form a current mirror circuit with the transistor TR12. Therefore, the current flowing through the drain of the transistor TR13 indicated by D3 is a current obtained by mirroring the current indicated by D1 described above. Similarly, the current flowing through the drain of the transistor TR14 indicated by D4 is a current obtained by mirroring the current indicated by D1 described above. When the gate size of the transistor TR13 and the gate size of the transistor TR14 are the same, the magnitude of the current flowing through the drain of the transistor TR13 indicated by D3 and the magnitude of the current flowing through the drain of the transistor TR14 indicated by D4 are the same.

By coupling the drain of the transistor TR13 to the output node of the first bias current BC1 and coupling the drain of the transistor TR14 to the output node of the second bias current BC2, the first bias current BC1 and the second bias current BC2 can be generated as the same current. That is, the current indicated by D3 in FIG. 8 corresponds to the first bias current BC1, the current indicated by D4 in FIG. 8 corresponds to the second bias current BC2, and the internal bias current of the bandgap reference circuit 101 is mirrored. The drain of the transistor TR11 may be coupled to the bias input node of the comparison circuit 130.

Note that, although not illustrated, the pairs of transistors forming the current mirror circuits may be arranged in the so-called common centroid layout in which the positions of the centers of gravity of the pairs of transistors in the layout coincide with one another. According to the configuration, the difference in magnitude between the mirrored currents can be further reduced.

As described above, the circuit device 10 of the present embodiment includes the temperature detection circuit 100 and the bandgap reference circuit 101, and the bias current generation circuit 102 generates the first bias current BC1 and the second bias current BC2 by mirroring the internal bias current of the bandgap reference circuit 101. According to the configuration, the bias current generation circuit 102 that generates the first bias current BC1 and the second bias current BC2 based on the bandgap reference circuit 101 can be constructed.

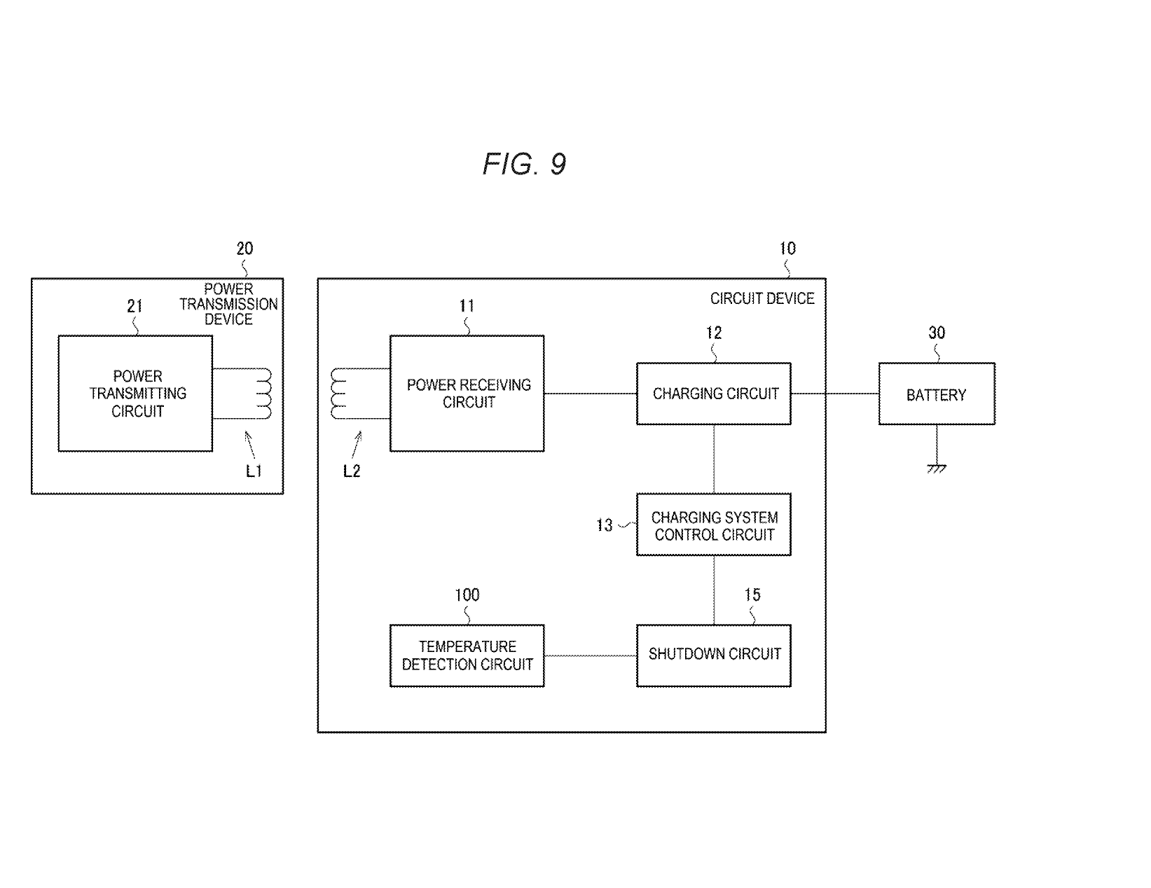

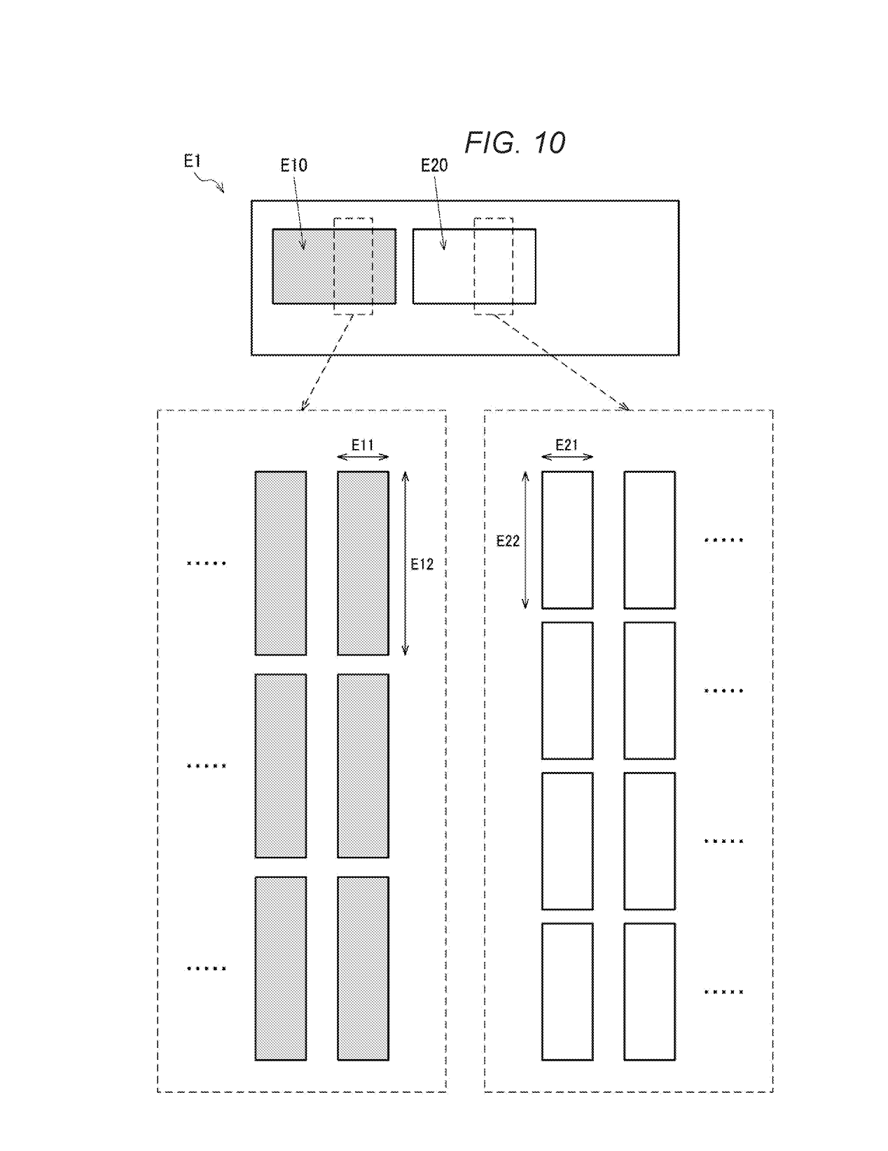

More specifically, the circuit device 10 of the present embodiment may have a configuration example shown in FIG. 9. The circuit device 10 of FIG. 9 further includes a power receiving circuit 11, a charging circuit 12, and a charging system control circuit 13 in addition to the configuration shown in FIG. 2. The circuit device 10 in FIG. 9 may form a contactless power transmission system together with a power transmission device 20. In this case, the circuit device 10 operates as a power receiving device that receives power from the power transmission device 20 in a contactless manner.

The power transmission device 20 is a device that transmits power to the circuit device 10 in a contactless manner, and includes a power transmitting circuit 21 and a primary coil indicated by L1. The power transmitting circuit 21 includes a power transmission driver that drives the primary coil, a power supply circuit that supplies electric power to the power transmission driver, and a capacitor forming a resonance circuit in conjunction with the primary coil. The power transmitting circuit 21 having the above-described configuration generates an AC voltage having a predetermined frequency at the time of power transmission and supplies the AC voltage to the primary coil. The primary coil is electromagnetically coupled to a secondary coil, which will be described later, to form a power transmission transformer. For example, when power transmission is necessary, a magnetic flux of the primary coil is set to pass through the secondary coil. In contrast, when the power transmission is unnecessary, the magnetic flux of the primary coil is set not to pass through the secondary coil. Although not illustrated, the power transmission device 20 further includes a power-transmission-side control circuit that performs various kinds of control on a power transmission side. Specifically, for example, the power-transmission-side control circuit includes a communication circuit, a power supply voltage control circuit, a clock generation circuit, and a driver control circuit. The communication circuit receives power transmission voltage setting information from a power reception side. The power supply voltage control circuit generates a drive voltage for driving the power transmission driver based on the power transmission voltage setting information. The clock generation circuit generates a drive clock signal that specifies a power transmission frequency. The driver control circuit controls the power transmission driver based on the drive voltage and the drive clock signal.

The charging system control circuit 13 controls the charging circuit 12 and executes various kinds of control processing performed during charging of a battery 30. The charging system control circuit 13 can be implemented by various processors including a logic circuit generated by an automatic placement and routing method such as a gate array or a digital signal processor (DSP). The power receiving circuit 11 converts an AC induced voltage of the secondary coil indicated by L2 into a DC rectified voltage. That is, the power receiving circuit 11 includes a rectifier circuit (not illustrated). The rectifier circuit can be implemented by, for example, a plurality of transistors or diodes. The charging circuit 12 supplies power to the battery 30 based on the power related to the rectified voltage converted by the power receiving circuit 11. The configuration of the circuit device 10 is not limited to that in FIG. 9, and may further include, for example, a communication circuit that transmits communication data to the power transmission device 20. The charging system control circuit 13 may further control the communication circuit and the power receiving circuit 11, and various modifications can be made.

In the circuit device 10 having the above-described configuration, for example, when the ambient temperature of the temperature detection circuit 100 reaches the detection target temperature TD, the detection signal output from the comparison circuit 130 changes. Thus, the shutdown circuit 15 shuts down the charging system control circuit 13. For example, a signal for setting the shutdown mode is output from the shutdown circuit 15 to the charging system control circuit 13, and the charging system control circuit 13 does not perform control to charge the battery 30 during the shutdown mode.

From the above, the circuit device 10 of the present embodiment includes the power receiving circuit 11 that receives power by contactless power transmission, the charging circuit 12 that charges the battery 30 based on the received power, and the charging system control circuit 13 that controls the charging circuit 12, and the shutdown circuit 15 shuts down the charging system control circuit 13. According to the configuration, it is possible to construct the circuit device 10 that shuts down the charging system control circuit 13 when the ambient temperature reaches the detection target temperature TD.

For example, in the temperature detection circuit 100 of the present embodiment, the layout design of the diffusion resistor and the polysilicon resistor may be made in the following manner. In a chip layout conceptually indicated by E1 in FIG. 10, a portion indicated by E10 is a layout related to diffused resistors, and a portion indicated by E20 is a layout related to polysilicon resistors.

In the layout indicated by E10, a large number of rectangular diffusion resistors are arranged in a grid pattern. Here, a length along the direction in which a current flows, that is, a length of the long side of the rectangle is referred to as a "length", and a length perpendicular to the direction in which the current flows, that is, a length of the short side of the rectangle is referred to as a "width". That is, a large number of diffusion resistors having a width indicated by E11 and a length indicated by E12 are arranged in the layout indicated by E10. Similarly, a large number of rectangular polysilicon resistors having a width indicated by E21 and a length indicated by E22 are arranged in the layout indicated by E20.

Here, the width indicated by E11 and the width indicated by E21 are the same. The term "same" includes an error range that can be regarded as substantially the same. That is, in the temperature detection circuit 100 of the present embodiment, the widths of the polysilicon resistor and the diffusion resistor are the same in the first resistance circuit 110. According to the configuration, the resistance ratio between the polysilicon resistor and the diffusion resistor is determined only by the relationship between the length of the polysilicon resistor and the length of the diffusion resistor. Thus, the resistance ratio between the polysilicon resistor and the diffusion resistor can be easily set.

As described above, the temperature detection circuit of the present embodiment includes the bias current generation circuit that generates the first bias current and the second bias current, the first resistance circuit through which the first bias current flows, the second resistance circuit through which the second bias current flows, and the comparison circuit. The comparison circuit compares the first voltage generated by the first bias current flowing through the first resistance circuit with the second voltage generated by the second bias current flowing through the second resistance circuit and having the second voltage-temperature characteristic different from the first voltage-temperature characteristic of the first voltage, and outputs the comparison result as the temperature detection signal.

As described above, since the temperature detection circuit of the present embodiment uses the first resistance circuit and the second resistance circuit to make the first voltage-temperature characteristic and the second voltage-temperature characteristic different from each other, it is possible to make the comparison result different at a desired temperature with the simpler circuit configuration.

The first voltage-temperature characteristic and the second voltage-temperature characteristic may intersect at the detection target temperature.

According to the configuration, since the detection signal output from the comparison circuit can be made different at the detection target temperature, the temperature detection circuit that detects the detection target temperature can be constructed.

The second resistance circuit may be the variable resistance circuit whose resistance value is set by the trimming value, and the trimming value may be set such that the first voltage-temperature characteristic and the second voltage-temperature characteristic intersect at the detection target temperature.

This makes it easy to adjust the detection target temperature in consideration of manufacturing variations.

The first resistance circuit may be the variable resistance circuit set at the different resistance value between the normal mode and the test mode, and the resistance value of the first resistance circuit may be the resistance value corresponding to the test temperature lower than the detection target temperature in the test mode. In the test mode, the first voltage-temperature characteristic and the second voltage-temperature characteristic may be set so as to intersect at the test temperature, and in the normal mode, the trimming value may be set so that the first voltage-temperature characteristic and the second voltage-temperature characteristic intersect at the detection target temperature.

According to the configuration, the circuit device including the temperature detection circuit can be tested in the environment of the test temperature lower than the detection target temperature. This makes it possible to facilitate testing.

The resistance value of the first resistance circuit may have the first resistance-temperature characteristic, and the resistance value of the second resistance circuit may have the second resistance-temperature characteristic different from the first resistance-temperature characteristic.

According to the configuration, the first voltage-temperature characteristic and the second voltage-temperature characteristic can be made different from each other.

The first resistance-temperature characteristic may be the flat temperature characteristic, and the second resistance-temperature characteristic may be the positive or negative temperature characteristic.

According to the configuration, the intersection of the first resistance-temperature characteristic and the second resistance-temperature characteristic can be easily set.

The first resistance circuit may include the resistor having the positive temperature characteristic and the resistor having the negative temperature characteristic, and the second resistance circuit may include the resistor having the positive or negative temperature characteristic.

According to the configuration, the first resistance-temperature characteristic and the second resistance-temperature characteristic can be made different from each other.

In addition, the first resistance circuit may include the polysilicon resistor and the diffusion resistor, and the second resistance circuit may include the polysilicon resistor or the diffusion resistor.

According to the configuration, the temperature detection circuit including the first resistance circuit and the second resistance circuit using the polysilicon resistor and the diffusion resistor can be constructed.

The widths of the polysilicon resistor and the diffusion resistor may be the same in the first resistance circuit.

According to the configuration, the resistance ratio between the polysilicon resistor and the diffusion resistor can be easily set.

In the first resistance circuit, the resistance ratio between the polysilicon resistor and the diffusion resistor may be the resistance ratio at which the first resistance-temperature characteristic becomes the flat temperature characteristic.

According to the configuration, the first resistance circuit having the flat temperature characteristic can be constructed using the polysilicon resistor having the negative temperature characteristic and the diffusion resistor having the positive temperature characteristic.

The diffusion resistor of the first resistance circuit may include the n first unit resistors (n is an integer of 2 or more), the polysilicon resistor of the first resistance circuit may include the n second unit resistors, the n first unit resistors and the n second unit resistors may be coupled in series, and the resistance ratio between the first unit resistor and the second unit resistor may be the same as the resistance ratio between the polysilicon resistor and the diffusion resistor.

According to the configuration, the first resistance circuit having the flat first temperature characteristic can be constructed by the first unit resistance and the second unit resistance.

The first resistance circuit may include the switch for the test mode, and the switch may be coupled in parallel to the k first unit resistors (k is an integer of 1 or more and less than n) and the k second unit resistors.

According to the configuration, since the resistance value of the first resistance circuit can be changed, the first resistance-temperature characteristic and the second resistance-temperature characteristic can be made to intersect at the lower temperature in the test mode.

Further, the present embodiment relates to the circuit device including the temperature detection circuit and the bandgap reference circuit described above, in which the bias current generation circuit generates the first bias current and the second bias current by mirroring the internal bias current of the bandgap reference circuit.

According to the configuration, it is possible to construct the bias voltage generation circuit that generates the first bias current and the second bias current based on the bandgap reference circuit.

The present embodiment relates to the circuit device including the temperature detection circuit described above and the shutdown circuit that performs the shutdown operation of the circuit device when the detection signal indicating that the temperature has reached the detection target temperature is output.

According to the configuration, it is possible to construct the circuit device that performs the shutdown operation based on the detection signal output from the temperature detection circuit that exhibits the effects of the present embodiment.

The circuit device described above may include the power receiving circuit that receives power by contactless power transmission, the charging circuit that charges the battery based on the received power, and the charging system control circuit that controls the charging circuit, and the shutdown circuit may shut down the charging system control circuit.

According to the configuration, it is possible to construct the circuit device that shuts down the charging system control circuit 13 when the ambient temperature reaches the detection target temperature.

Note that while the present embodiment has been described in detail above, a person skilled in the art could readily understand that many modifications can be made without substantively departing from the novel matters and effects of the present disclosure. Therefore, all such modifications should fall within the scope of the present disclosure. For example, a term described at least once together with a different term having a broader meaning or the same meaning in the specification or the drawings can be replaced with the different term in any part of the specification or the drawings. All combinations of the present embodiment and the modifications also fall within the scope of the present disclosure. The configurations, operations, and the like of the temperature detection circuit, the circuit device, and the like are not limited to those described in the present embodiment, and various modifications can be made.

What is claimed is:

1. A temperature detection circuit comprising:
a bias current generation circuit configured to generate a first bias current and a second bias current;
a first resistance circuit configured to conduct the first bias current flows;
a second resistance circuit configured to conduct the second bias current flows; and
a comparison circuit configured to compare a first voltage generated by the first bias current flowing through the first resistance circuit with a second voltage generated by the second bias current flowing through the second resistance circuit and having a second voltage-temperature characteristic different from a first voltage-temperature characteristic of the first voltage, and outputs a comparison result as a temperature detection signal.

2. The temperature detection circuit according to claim 1, wherein
the first voltage-temperature characteristic and the second voltage-temperature characteristic intersect at a detection target temperature.

3. The temperature detection circuit according to claim 2, wherein
the second resistance circuit is a variable resistance circuit whose resistance value is set based on a trimming value, and
the trimming value being configured to cause the first voltage-temperature characteristic and the second voltage-temperature characteristic intersect at the detection target temperature.

4. The temperature detection circuit according to claim 3, wherein
the first resistance circuit is a variable resistance circuit set at different resistance values in a normal mode and a test mode,
the resistance value of the first resistance circuit is a resistance value corresponding to a test temperature lower than the detection target temperature in the test mode, and
the first voltage-temperature characteristic and the second voltage-temperature characteristic are set to intersect at the test temperature in the test mode, thereby setting the trimming value to make the first voltage-temperature characteristic and the second voltage-temperature characteristic intersect at the detection target temperature in the normal mode.

5. The temperature detection circuit according to claim 1, wherein
a resistance value of the first resistance circuit has a first resistance-temperature characteristic, and
a resistance value of the second resistance circuit has a second resistance-temperature characteristic different from the first resistance-temperature characteristic.

6. The temperature detection circuit according to claim 5, wherein
the first resistance-temperature characteristic is a flat temperature characteristic, and
the second resistance-temperature characteristic is a positive or negative temperature characteristic.

7. The temperature detection circuit according to claim 5, wherein
the first resistance circuit includes a resistor having a positive temperature characteristic and a resistor having a negative temperature characteristic, and
the second resistance circuit includes a resistor having a positive or negative temperature characteristic.

8. The temperature detection circuit according to claim 7, wherein
the first resistance circuit includes a polysilicon resistor and a diffusion resistor, and
the second resistance circuit includes the polysilicon resistor or the diffusion resistor.

9. The temperature detection circuit according to claim 8, wherein
widths of the polysilicon resistor and the diffusion resistor are the same in the first resistance circuit.

10. The temperature detection circuit according to claim 8, wherein
in the first resistance circuit, a resistance ratio between the polysilicon resistor and the diffusion resistor is a resistance ratio at which the first resistance-temperature characteristic is a flat temperature characteristic.

11. The temperature detection circuit according to claim 10, wherein
the diffusion resistor of the first resistance circuit includes n first unit resistors, n being an integer of 2 or more,
the polysilicon resistor of the first resistance circuit includes n second unit resistors,
the n first unit resistors and the n second unit resistors are coupled in series, and
a resistance ratio between the first unit resistor and the second unit resistor is the same as a resistance ratio between the polysilicon resistor and the diffusion resistor.

12. The temperature detection circuit according to claim 11, wherein
the first resistance circuit includes a switch for the test mode, and
the switch is coupled in parallel to the k first unit resistors, k being an integer of 1 or more and less than n, and the k second unit resistors.

13. A circuit device comprising:
the temperature detection circuit according to claim 1; and
a bandgap reference circuit, wherein
the bias current generation circuit generates the first bias current and the second bias current by mirroring an internal bias current of the bandgap reference circuit.

14. A circuit device comprising:
the temperature detection circuit according to claim 1; and
a shutdown circuit is configured to perform a shutdown operation of the circuit device when the detection signal indicating that a temperature reaches a detection target temperature is output.

15. The circuit device according to claim 14, further comprising:
a power receiving circuit configured to receive power by contactless power transmission;
a charging circuit configured to charge a battery based on the received power; and
a charging system control circuit configured to control the charging circuit, wherein
the shutdown circuit shuts down the charging system control circuit.
